(19) United States
(12) Patent Application Publication
(10) Pub. No.: US 2004/0113957 A1
(43) Pub. Date: Jun. 17, 2004

(54) Color image printing apparatus and control method thereof

(75) Inventor: Jeong-Soo Han, Seongnam-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Gyeonggi-do (KR)

(21) Appl. No.: 10/727,632

(22) Filed: Dec. 5, 2003

(30) Foreign Application Priority Data
Dec. 6, 2002 (KR) 2002-77329

(51) Int. Cl. B41J 2/01

(52) U.S. Cl. 347/1

(57) ABSTRACT

A color image printing apparatus and a control method thereof. The color image printing apparatus includes a storage unit for separately storing image data of plural colors in corresponding memory regions, the image data being divided according to corresponding colors applied to print data that are received from an external device, a plurality of developing devices containing toners of plural colors, being driven in accordance with the image data stored in the memory regions, and a control unit, with determining that there are color data existing in the mage data stored in the memory regions for the purpose of color image developing, driving a developing device of color toner that corresponds to the memory region containing the color data to feed the color toner. By driving a developing device that contains a color developer corresponding to the memory region where color data exist, printing speed improves.

### CROSS-REFERENCE TO RELATED APPLICATIONS

This application claims the benefit of Korean Patent Application No. 2002-77329, filed Dec. 6, 2002, in the Korean Intellectual Property Office, the disclosure of which is incorporated herein by reference.

### BACKGROUND OF THE INVENTION

1. Field of the Invention

The present invention relates to a color image printing apparatus and a control method thereof, and more particularly, to a color image printing apparatus capable of printing color images by using developing devices, representing different colors, for color image development, and a control method thereof.

2. Description of the Related Art

Generally, an image printing apparatus refers to a type of apparatus which prints an image on a recording medium. Photocopiers, printers, and facsimiles are a few examples of image printing apparatuses. Depending on the printing method that is adopted for the image printing apparatus, the apparatus is categorized into either an inkjet printing type or a laser printing type.

A laser printing type of color image printing apparatus generally includes a laser scanning unit, a photosensitive medium that forms an electrostatic latent image thereon in correspondence with the light emitted from the laser scanning unit, a developing unit that develops the electrostatic latent image of the photosensitive medium, and a transfer unit that transcribes the developed image onto a recording medium. For the purpose of color image development, the developing unit is provided with a plurality of developing devices that feed toners of various colors, such as yellow, magenta, cyan and black, to the image printing apparatus.

The printing operation of the above-described color image printing apparatus is as follows.

First, a control unit, which controls the overall operation of the color image printing apparatus, divides the print data into yellow image data (Y), cyan image data (C), magenta image data (M), and black image data (K). The respective color image data are stored into memory regions for the respective colors. The control unit outputs to the laser scanning unit the image data with respect to the stored Y, C, M and K color image data.

The laser scanning unit irradiates a light, corresponding to respective color image data input from the control unit, onto the surface of the photosensitive medium. For example, when the laser scanning unit irradiates a light corresponding to the yellow color image data. Accordingly, an electrostatic latent image is formed on the surface of the photosensitive medium. Next, the yellow developing device forms a yellow developed image on the electrostatic latent image of the photosensitive medium. The yellow developed image is then transcribed onto the transfer belt.

Then the laser scanning unit irradiates a light corresponding to the cyan color image. As a result, a new electrostatic latent image is formed on the surface of the photosensitive medium. Using the toner from the cyan developing unit, a cyan developed image is formed on the area where the electrostatic latent image is formed. The cyan developed image is transcribed onto the transfer belt where the yellow developed image was already formed.

The developing and transcribing process goes on as described above with the other toners, i.e., magenta after cyan, and black after magenta. In the end, the image is finalized in the combination of the yellow, cyan, magenta and black developed images. The finalized image is then transcribed onto the recording medium. As the image is fixed by the fusing unit, the printing process is finished.

Generally, when the color print data is transmitted from an external device, the divided image data, i.e., Y, C, M and K color image data, are output together through the laser scanning unit. Image data that does not contain color data is transmitted to the laser scanning unit along with image data containing color data. As a result, developing devices that are not assigned a developing job are driven.

For example, in order to output a document in red, it would be beneficial to drive only the yellow and magenta developing devices. In conventional devices, however, all four of the developing devices are driven. Accordingly, even if there is no color data corresponding to the cyan and black developing devices, and thus no need for the cyan and black developing devices to perform a developing process, the cyan and black developing devices are still driven. By driving the developing devices that do not perform any process, the printing speed is slowed, and the life span of the printing apparatus is shortened.

### SUMMARY OF THE INVENTION

Additional aspects and/or advantages of the invention will be set forth in part in the description which follows and, in part, will be obvious from the description, or may be learned by practice of the invention.

Accordingly, it is an object of the present invention to provide a color image printing apparatus capable of selectively driving developing devices for the printing of color images, that is, driving only the developing devices that correspond to the color that is applied during printing, and a control method thereof.

In order to achieve the above object and/or other aspects and features of the present invention, a color image printing apparatus is used. The color image printing apparatus includes a storage unit for separately storing image data of multiple colors in corresponding memory regions. The image data is divided according to the colors to be applied while printing data that are received from an external device. The color image printing device also includes a plurality of developing devices that contain toners of different colors, the developing devices are driven in accordance with the image data stored in the memory regions. Also included is a control unit which determines if there are color data existing in the image data stored in the memory regions for the purpose of color image developing. The control unit then drives a developing device of color toner, corresponding to the memory region containing the color data, to feed the color toner.

The colors of the image data are composed of yellow, cyan, magenta and black.

Further provided is a driving select unit for selectively driving the plurality of developing devices. The control unit controls the driving select unit as it drives the developing device that contains the color toner corresponding to the memory region containing the color data.

The control unit has a data separating unit that separates the print data into image data based on the colors in the print data. The image data divided by the data separating unit are stored in the memory regions of the storage unit.

Meanwhile, according to an aspect of the present invention, there is a control method for a color image printing apparatus developing an electrostatic latent image of a photosensitive medium by using a plurality of developing devices that feed toners of multiple colors. The control method for a color image printing apparatus according to an aspect of the present invention includes the steps of determining whether print data from an external device is a monochromatic data or a color data. If the print data are color data, the print data are divided into image data of multiple colors based on the color information in the print data, and storing the divided image data in memory regions of respective colors. If there are color data in the image data stored in the memory regions, for the purpose of color image developing, a developing device of color toner corresponding to the memory region containing the color data to feed the color toner is driven.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an image printing system having a color image printing apparatus according to an embodiment of the present invention;

FIG. 2 is a view illustrating an example of image data being stored to the memory regions for respective colors;

FIG. 3 is a schematic sectional view of the printing engine unit of FIG. 1; and

FIG. 4 is a flowchart for illustrating a control method of the color image printing apparatus of FIG. 1.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

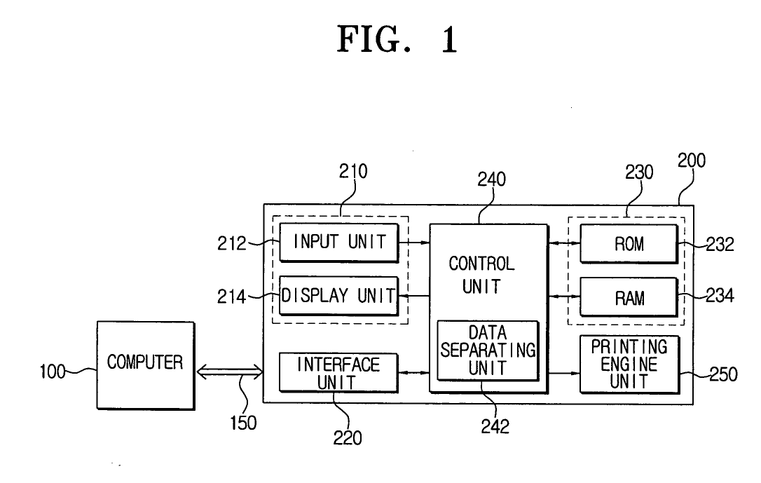

FIG. 1 is a block diagram of an image printing system having a color image printing apparatus according to an embodiment of the present invention.

Referring to FIG. 1, the image printing system includes a computer 100 connected to a color image printing apparatus 200 by a communication interface 150.

The computer 100 serves as an external device that transmits the data for printing to the color image printing apparatus 200. A printer driver (not shown) installed in the computer 100 converts selected files of data into print data, readable by the color image printing apparatus 200 and transmits the converted data to the color image printing apparatus 200 through the communication interface 150.

The color image printing apparatus 200 processes the print data transmitted from the computer 100 so that images can be formed on a recording medium.

The color image printing apparatus 200 includes an operating panel 210, an interface unit 220, a storage unit 230, a control unit 240 and a printing engine unit 250.

The operating panel 210 includes an input unit 212, which is provided with a plurality of keys for setting supportable functions of the color image printing apparatus 200, and a display unit 214 which, under the control of the control unit 240, displays the operational status of the color image printing apparatus 200.

The interface unit 220 is connected with the computer 100 through the communication interface 150 and provides the mutual data communications. A universal serial bus (USB) is one example of the interface unit 220.

The storage unit 230 consists of read only memory (ROM) 232 and random access memory (RAM) 234.

The ROM 232 is a non-volatile memory, and stores various control programs to help utilize functions of the color image printing apparatus 200.

The RAM 234 is a volatile memory, and temporarily stores print data transmitted from the computer 100 through the interface unit 220, as well as and various types of data that are generated during the operation of the color image printing apparatus 200.

The RAM 234 is divided into memory regions representing different colors, i.e., yellow, magenta, cyan and black, for separately storing the image data of like color. The memory regions are adaptively divided in accordance with the volume of print data being transmitted from the computer 100 through the interface unit 220. The volume of the print data may vary in accordance with the size of the selected recording medium.

The color image printing apparatus 200 prints color data by combining yellow, cyan, magenta and/or black toners. For example, a red color image utilizes a combination of yellow and cyan toners.

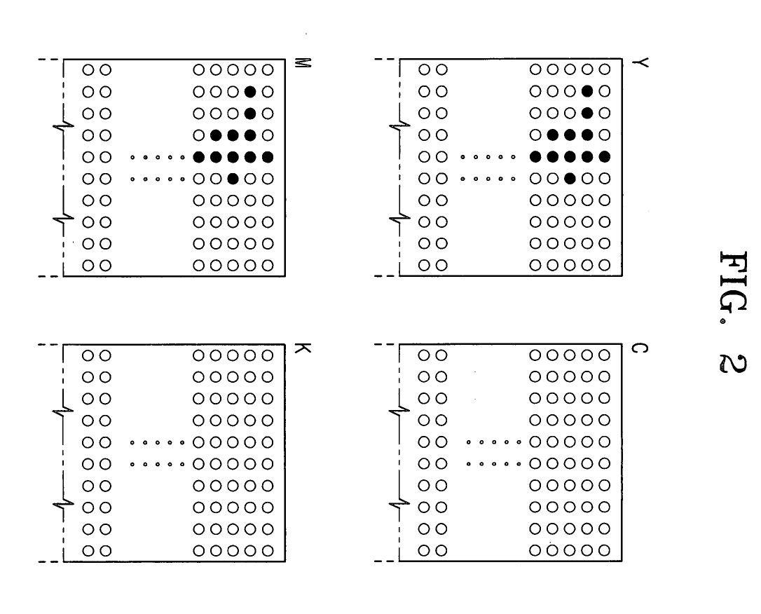

FIG. 2 is a view illustrating image data being stored in the memory regions of the RAM 234, when print data, here colored red, is received from the computer 100.

As shown in FIG. 2, stored in the memory regions are the Y, C, M, and K image data which are divided according to the color information of the received print data. The image data stored to the memory regions have a value of ‘1’ or ‘0’. Image data with a value of ‘1’ is color data which is used for developing the color of the received print data, while image data with a value of ‘0’ is non-color data which is not used for the developing of the color in the print data. The color data of value ‘1’ is represented by a black dot, and the non-color data of value ‘0’ is represented by a white dot.

For example, in order to develop print data, which is applied with red color, color data are stored only in the yellow and magenta memory regions. The data are stored in predetermined areas corresponding to position in the received print data.

Meanwhile, because cyan and black colors are not required to develop the red color, only the non-color data are stored in the cyan and black memory regions.

As power is applied to the color image printing apparatus 200, the control unit 240 controls overall operation of the color image printing apparatus 200 according to the control programs stored in the storage unit 230.

The control unit 240, determines whether print data received from the computer 100 are monochromatic data or color data. The control unit 240 may have a data separating unit 242 that divides the print data into Y, C, M, and K image data when the color data are received from the computer 100.

The data separating unit 242 is controlled by the control unit 240, and divides the color data into Y, C, M, and K image data. If receiving the Y, C, M and K image data already divided by the computer 100, the control unit 240 does not drive the data separating unit 242.

The control unit 240 stores the Y, C, M and K image data in the respective memory regions of the RAM 234.

Prior to transmitting the image data to the printing engine unit 250, the control unit 240 checks the respective memory regions and determines whether there is color data in the stored image data. If there is color data, the control unit 40 drives a developing device containing a color toner corresponding to the memory region where the color data is found.

Concurrently, the developing devices of the developers that correspond to the memory regions where there is no color data are not driven. In other words, the image data corresponding to the memory regions having no color data therein is not transmitted to the printing engine unit 250.

More specifically, the control unit 240 checks the respective memory regions and, if determining there is data in the memory region representing at least one color, the control unit 240 transmits the image data corresponding to the memory region to the printing engine unit 250. The developing device having the corresponding color developer can then be driven.

The printing engine unit 250, under the control of the control unit 240, prints the image data.

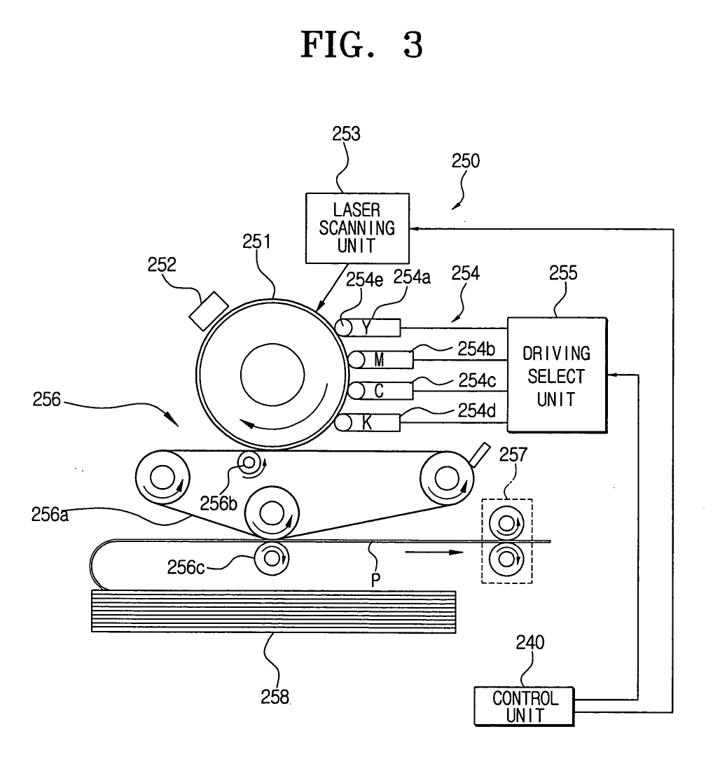

FIG. 3 is a schematic sectional view of the printing engine unit 250 of FIG. 1.

Referring to FIG. 3, the printing engine unit 250 includes a photosensitive drum 251, a charger 252, a laser scanning unit 253, a developing unit 254, a driving select unit 255, a transfer unit 256, a fusing unit 257, and a paper feeding unit 258.

The charger 252 charges the photosensitive drum 251, i.e., the photosensitive medium, with a predetermined voltage.

The laser scanning unit 253 is controlled by the control unit 240, and irradiates a light on the photosensitive drum 251 corresponding to the image data transmitted from the control unit 240. As a result, an electrostatic latent image is formed on the surface of the photosensitive drum 251.

The developing unit 254 includes Y, C, M, and K developing devices 254a, 254b, 254c, 254d from which Y, C, M, and K color toners are jumped onto the photosensitive drum 251 where the electrostatic latent image is formed, thereby developing the electrostatic latent image.

The respective developing devices 254a, 254b, 254c, 254d are provided with developing rollers 254e which are sequentially disposed in non-contact relation with the surface of the photosensitive drum 251, i.e., at predetermined distance from the surface of the photosensitive drum 251. The respective developing devices 254a, 254b, 254c, 254d are driven sequentially in a predetermined order, and with the color toner thereof. The developing devices 254a, 254b, 254c, 254d function to develop the electrostatic latent image formed on the photosensitive drum 251 by the laser scanning unit 253.

The respective developing devices 254a, 254b, 254c, 254d are selectively driven by the selection signal of the driving select unit 255. The driving select unit 255 performs on/off switching so that only the developing devices 254a, 254b, 254c, 254d that correspond to the control signal from the control unit 240 can be driven. Accordingly, only the selected developing devices 254a, 254b, 254c, 254d are driven.

The transfer unit 256 includes a transfer belt 256a, which is the transferring medium of the toner image from the photosensitive drum 251, a first transfer roller 256b that transcribes the toner image from the photosensitive drum 251 to the transfer belt 256a, and a second transfer roller 256c that transfers the toner image onto the recording medium P.

The transfer unit 256 transcribes the yellow, magenta, cyan and black toner images onto the recording medium P that is fed from the paper feeding unit 258.

The fusing unit 257 fixes the final image on the recording medium P with heat and pressure.

As described above, since only the developing device 254a, 254b, 254c, 254d that corresponds to the memory region where the color data exist is driven, printing speed improves.

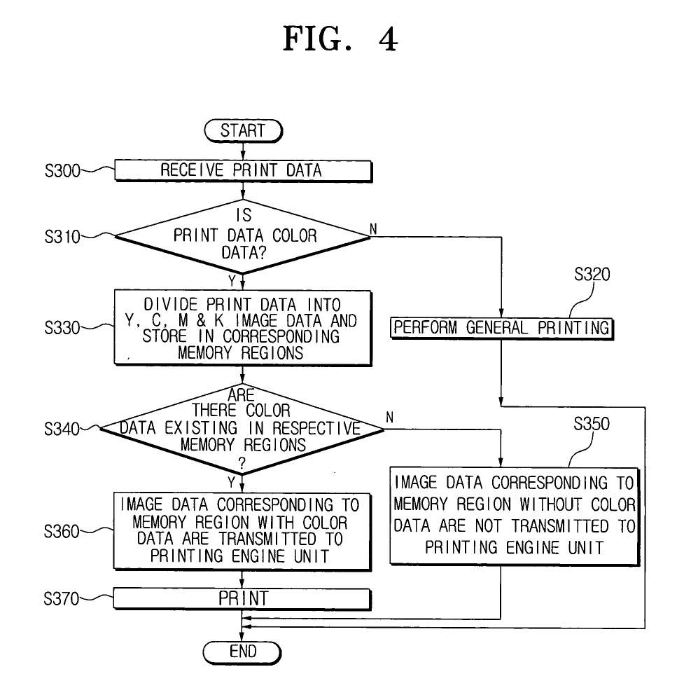

Hereinafter, a control method of the color image printing apparatus according to an aspect of the present invention will be described with reference to FIG. 4.

When the data for printing is received from the external device, i.e., from the computer 100 through the interface unit 220 at operation S300, the control unit 240 at operation S310 determines whether the incoming print data is monochromatic data or color data.

If the data received from the computer 100 at operation S310 is monochromatic, the control unit 240 at operation S320 temporarily stores the print data in the storage unit 230, and then transmits the stored print data to the printing engine unit 250 for printing. At this time, the RAM 234 memory region is not divided. Also, only the K developing device 254d that feeds the black toner is driven. When the print data is monochromatic data, the printing process is similar to that of a conventional color image printing apparatus, therefore a detailed description thereof will be omitted.

If it is determined at operation S310 that color data are received from the computer 100, the control unit 240 controls the data separating unit 242 to divide the print data into Y, C, M, and K image data based on the color information in the print data. Image data corresponding to the Y, C, M, and K colors which are divided by the data separating unit 242 are stored in the respective memory regions of the RAM 234 at operation S330.

Next, at operation S340, the control unit 240 checks the memory regions prior to transmitting the stored image data to the printing engine unit 250 and determines whether there are color data existing in the memory regions.

If it is determined at operation S340, that there are memory regions where color data are not present, the control unit 240 does not transmit the image data corresponding to the memory region to the printing engine unit 250 at operation S350. Accordingly, the developing devices 254a, 254b, 254c, 254d that correspond to the memory regions that have only non-color data, are not driven.

If it is determined at operation S340 that there is a memory region having color data, the control unit 240 at operation S360 transmits image data to the printing engine unit 250 corresponding to the memory region where color data exist.

At operation S370, the printing engine unit 250 performs printing, using the image data input from the control unit 240.

The printing operation of the printing engine unit 250 will be described below, for an instance in which color data exist only in the yellow and magenta memory regions.

Initially, light is irradiated from the laser scanning unit 253 onto the surface of the photosensitive drum 251, which has been charged by the charger 252 with a predetermined voltage. As a result, an electrostatic latent image is formed on the surface of the photosensitive drum 251. Then, by controlling the driving select unit 255, the control unit 240 drives the Y developing device 254a. The Y developing device 254a discharges a yellow toner in accordance with the driving signal from the driving select unit 255. The yellow toner jumps onto the electrostatic latent image of the photosensitive drum 251, forming a yellow toner image. The yellow toner image is transcribed onto the transfer belt 256a.

After the transfer of the yellow toner image, a new electrostatic latent image is formed on the photosensitive drum 251 from a light irradiated from the laser scanning unit 253. The control unit 240 controls the driving select unit 255 to drive the M developing device 254c. The M developing device 254c discharges a magenta toner in accordance with the driving signal from the driving select unit 255. Accordingly, magenta toner jumps onto the electrostatic latent image of the photosensitive drum 251, forming a magenta toner image thereon. The magenta toner image of the photosensitive drum 251 is transcribed onto the transfer belt 256a where the yellow toner image is already formed.

The final image in the form of combination of the yellow and magenta toner images, is transcribed onto the recording medium P by the transfer unit 256. The final image is fixed on the recording medium P by the fusing unit 257, and printing is completed. Accordingly, a red color image is printed on the recording medium P.

Meanwhile, where the print data from the computer 100 contain image data of all the colors, i.e., yellow, cyan, magenta, and black, printing of the color image is performed by forming yellow, cyan, magenta, and black toner images on the transfer belt 256a in the way described above. The developing can be performed in predetermined order and may vary in accordance with the printing method set for the image printing apparatus.

As described above, with the color image printing apparatus and a control method thereof according to the present invention, Y, C, M, and K developing devices can be selectively driven in accordance with the presence/absence of color data in the print data. That is, by selectively driving the developing device containing a color developer corresponding to the memory region where color data exist, printing speed is improved. Furthermore, since the developing devices which are not assigned with the developing job are not driven, the life span of the apparatus is prolonged.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A color image printing apparatus, comprising:
a storage unit to separately store image data of a plurality of colors in corresponding memory regions, wherein the image data is divided according to print data received from an external device;
a plurality of developing devices containing toners of a plurality of colors, wherein the developing devices are driven in accordance with the image data stored in the memory regions; and
a control unit, to determine if color data is present in the image data stored in the memory regions, and to drive a developing device of color toner that corresponds to the memory region containing the color data.

2. The color image printing apparatus of claim 1, wherein the plurality of colors of the image data comprise yellow, cyan, magenta, and black.

3. The color image printing apparatus of claim 1, wherein the control unit comprises a data separating unit to separate the print data into image data of a plurality of colors based on the colors applied in the printing data, wherein the image data separated by the data separating unit are respectively stored in the memory regions of the storage unit.

4. A method of controlling an image printing apparatus, the method comprising:
receiving print data;
determining if the print data is color data;
if the print data is not color data, performing general printing;
if the print data is color data, dividing the print data into a plurality of color image data, comprising, yellow image data, cyan image data, magenta image data, and black image data;
storing the color image data in corresponding memory regions; and
driving only developing devices that correspond to memory regions that contain stored color image data.

5. A color image printing apparatus, comprising:
an interface unit, to input print data from an external source;
a control unit, to control the operation of the color image printing apparatus;
a data separating unit, to separate the print data into a plurality of color data images;
a storage unit, to store the color data images in corresponding color data memory regions; and
a printing engine unit, having a plurality of developing devices that correspond to the color data memory regions;
wherein, during a printing operation, only the developing devices corresponding to color data memory regions that contain color data images are driven.

6. The color image printing apparatus of claim 5, further comprising a driving select unit for selectively driving the plurality of developing devices, wherein the control unit controls the driving select unit to drive only the developing devices corresponding to the memory regions containing the color data.

7. The color image printing apparatus according to claim 5, wherein the data separating unit is bypassed when the print data is separated into a plurality of color data images by the external device.

8. The color image printing apparatus according to claim 5, wherein the color data images comprise a yellow color data image, a cyan color data image, a magenta color data image, and a black color data image.

9. The color image printing apparatus according to claim 8, wherein the developing devices comprise; a yellow developing device, a cyan developing device, a magenta developing device, and a black developing device.

10. The color image printing apparatus according to claim 5, wherein the developing devices are fed by a plurality of color toners.

11. The color image printing apparatus according to claim 10, wherein the printing engine unit further comprises:
a photosensitive drum;
a laser scanning unit, to irradiate a light on the photosensitive drum, the light leaving an electrostatic latent image formed on a surface of the photosensitive drum, the electrostatic latent image corresponding to the print data;
a driving select unit, to selectively drive the developing devices when color image data corresponding to the developing device is present, so that the color toners are jumped from the developing devices onto the photosensitive drum, where the electrostatic latent image was formed, forming a toner image;
a transfer unit, to transfer the toner image from the photosensitive drum onto a recording medium; and
a fusing unit, to fix the toner image onto the recording medium, forming a final image.

12. The color image printing apparatus according to claim 11, further comprising a charger, to charge the photosensitive drum with a predetermined voltage.

13. A control method of a color image printing apparatus to develop an electrostatic latent image of a photosensitive medium by using a plurality of developing devices that feed toners of plural colors, the method comprising:
determining whether incoming print data from an external device is monochromatic data or color data; and
if the print data are color data,
dividing the print data into image data of plural colors based on color information contained in the print data, and
storing the divided image data in memory regions of respective colors; and
if there are color data existing in the image data stored in the memory regions for the purpose of color image developing, driving a developing device of color toner that corresponds to the memory region containing the color data to feed the color toner.

14. The control method of claim 13, wherein the plural colors of the image data correspond to yellow, cyan, magenta and black colors.
